(19) United States
(12) Patent Application Publication
(10) Pub. No.: US 2010/0131076 A1
(43) Pub. Date: May 27, 2010

(54) CONTROL SYSTEM, AND METHOD FOR CONFIGURING A CONTROL SYSTEM

(75) Inventors: Armando Walter Colombo, Karlstein (DE); Martin Feike, Mainz (DE)

Correspondence Address: DENNISON, SCHULTZ & MACDONALD, 1727 KING STREET, SUITE 105, ALEXANDRIA, VA, 22314, US

(73) Assignee: SCHNEIDER ELECTRIC AUTOMATION GMBH, Seligenstadt (DE)

(21) Appl. No.: 12/517,860

(22) PCT Filed: Dec. 7, 2007
(86) PCT No.: PCT/EP07/63526

§ 371 Date: Sep. 30, 2009

(30) Foreign Application Priority Data
Dec. 8, 2006 (DE) 10 2006 058 282.9

(51) Int. Cl. G05B 19/042; G06F 9/44; G06F 15/16

(52) U.S. Cl. 700/7; 717/104; 709/201

(57) ABSTRACT

The invention relates to a control system with service-oriented architecture for a flexible production system, comprising decentralized, distributed devices coupled together via a data communication system for the exchange of data, said devices having at least one software component and electrical and/or mechanical components. Said invention also relates to a method based on the development and implementation of service-oriented software components as component parts of a service-oriented architecture for decentralized, distributed devices in flexible production systems. In order to achieve the aim of making the control system configurable in a low-cost manner in the event of changes in the production system or different production scenarios, it is proposed that the software component is derived from a process or subprocess of a PPR model of the flexible production system, wherein each software component has a control logic derived from the process or subprocess, a flexible interface for access to resources represented in the PPR model, and a communications interface for integration into the service-oriented architecture.

The invention relates to a control system with service-oriented architecture for a flexible production installation, comprising devices distributed in a decentralized manner, coupled to each other via a data communication system for the exchange of data and with at least one software component as well as electrical and/or mechanical components as well as to a process for the configuration of a control system by the development and implementation of service-oriented software components as components of a service-oriented architecture for devices distributed in a decentralized manner in flexible production installations.

There is a change in the future of automatization technology from central controls to small, intelligent electronic devices and components that are intended for use in flexible production systems. This technology requires a new engineering process.

The beginning of a service-oriented architecture has established itself very successfully from the area of ERP systems (Enterprise Resource Planning Systems) for linking together various services for the IT support of various business processes. An example is described in P. Lalanda; L. Bellissard; R. Balter: “Asynchronous mediation for integrating business and operational processes”; IEEE; January-February 2006; Internet Computing, volume: 10, issue: 1, pp. 56-64. This beginning was not known up to the present in control- and automatization technology.

Furthermore, an important trend in the designing of new products and the planning for their production installations is the universal, integral consideration of the product life cycle that is currently being advanced in many companies under the keyword of “digital factory”. In this connection the linking of the central types product, process and resource (PPR model) has become accepted as data model.

Product installations must, analogous to products, also be considered under the aspect of the life cycle since otherwise there can be no guarantee for the flexibility of the installation.

Fixed characteristic numbers of the system are no longer in focus here such as, e.g., a certain output, but rather the capacity of a production installation to adjust itself to different situations. This capacity is ensured by flexible components that can be reconfigured.

Different production installations for different production scenarios cannot be developed on real installations. The construction of appropriate installations for examining these production scenarios is too expensive. Therefore, a virtual development environment is necessary. This concerns a software program with which products, processes and resources of the production installation can be virtually reproduced. Product installations can be virtually tested with such a development environment.

Diverse research subjects (see below) examine the possibility of using service-oriented architecture for devices and components distributed in a decentralized manner in flexible production installations; however, a concrete solution for the development of service components and technologies based on Web service have not been able to be indicated.

Methods, technologies and tools for the modeling, design and implementation of networked systems are being designed in the framework of the European “Integrated Product SOCRADES” that are made available by intelligent, embedded devices.

The target of this project (SOCRADES) is the development of so-called “middleware” technologies, i.e., application-independent technologies that offer services for switching between applications. They should be based on a service-oriented architecture (SOA) and include line and wireless network technologies as well as have an open interface. Furthermore, such software components should contain apparatus-specific functionalities.

An engineering process for developing a service-oriented architecture for components distributed in a decentralized manner in flexible production systems as well as a structure of the software components as service-oriented module was not previously known.

Starting from the above, the present invention has the basic problem of further developing a control system and a process for the configuration of a control system in such a manner that it can be configured with low cost upon changes in the production installation or in different production scenarios.

The problem is solved by a control system in accordance with the invention in that the software component is derived from a process or partial process of a PPR model of the flexible production system, in which each software component comprises a control logic derived from the process or partial process, comprises a flexible interface for access to resources represented in the PPR model as well as comprises a communication interface for integration in the service-oriented architecture.

Furthermore, the problem is solved by a process in accordance with the invention in that the following process steps are carried out:
Establishing of a PPR model of the flexible production system, taking into consideration product, process and resource information,
Breakdown of a production process contained in the PPR model into partial processes,
Development of the software components on the basis of the partial processes, in which each software component comprises a control logic derived from the partial process, a flexible interface for access to resources represented in the PPR model as well as comprises a communication interface for integration in the service-oriented architecture,
Development and analysis of different production scenarios as client-server architecture,
Implementation of the software components and of the associated client-service architecture into the control system.

The process steps are preferably carried out in a virtual development environment.

The control logic of a standardized software component is developed for a manufacturing process such as, e.g., a span sequence for fixing sheets to be welded. For installation planning a breakdown into partial processes has become accepted in practice, that is used as a guide for a control program. An engineering start based on components is therefore advantageously to be aligned according to the manufacturing process. This engineering process makes the functional elements available so that the service-oriented architecture can be used in the proper professional manner.

Various resources such as, e.g., actors, sensors, controls as well as electrical and/or mechanical components but also information and people are necessary for the processing of a process. The resources themselves are represented as virtual model in such a manner that their physical behavior can be reproduced in the most purposeful manner possible. In the development of the above-described software, also called services in the following, the reference to the resources is set by the PPR model.

The services as component of a combination of mechatronics, communication and intelligence are integrated into a total concept that assumes all control tasks. In the case of a service-oriented architecture they are preferably implemented as Web-service.

In a further process step, building on the standardized software components, a model of a life cycle for the production installation is developed. Care is to be taken here that a design is prepared not only for a specific target scenario but also that changing frame conditions are integrated into the planning setup.

Another process step is distinguished in that different production scenarios are presented and virtually analyzed as client-server architecture. The target here is that no re-programming of the production installation has to be carried out in practice if the frame conditions change. In contrast to the conventional procedure, different variants can be readily generated by a new client-server architecture in the service-oriented architecture used here.

Another preferred process step provides that the developed software components and the associated client-server architecture are implemented on different aggregation levels.

This brings it about that a continuous transition from a central control onto decentralized control components can be carried out. Here, the Web services can for their part invoke other Web services again. In a further step a library of generic Web services should preferably be generated.

Further details, features and advantages of the invention result not only from the claims, the features to be gathered from them, by themselves and/or in combination, but also from the following description of a preferred exemplary embodiment to be gathered from the drawings.

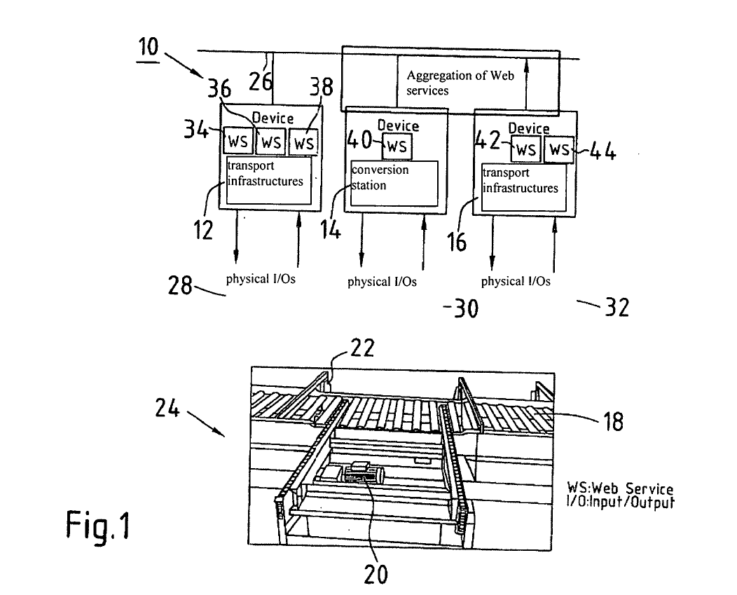

FIG. 1 shows a service-oriented architecture of a control system for a flexible production installation.

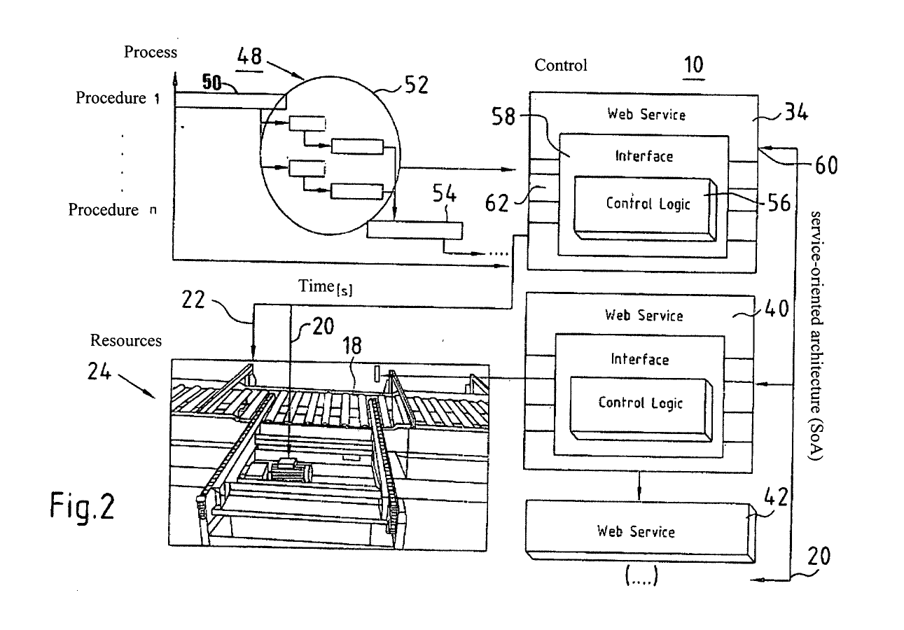

FIG. 2 shows a process graph of a virtual model of the production installation and Web services derived from it.

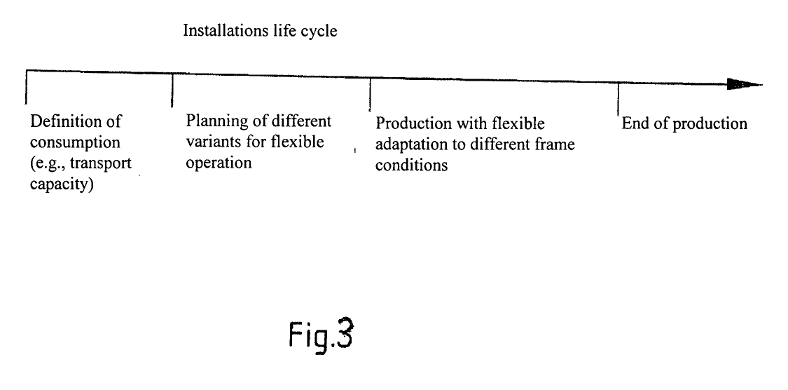

FIG. 3 shows an operating sequence diagram for establishing a model of a lifecycle for the production installation, and

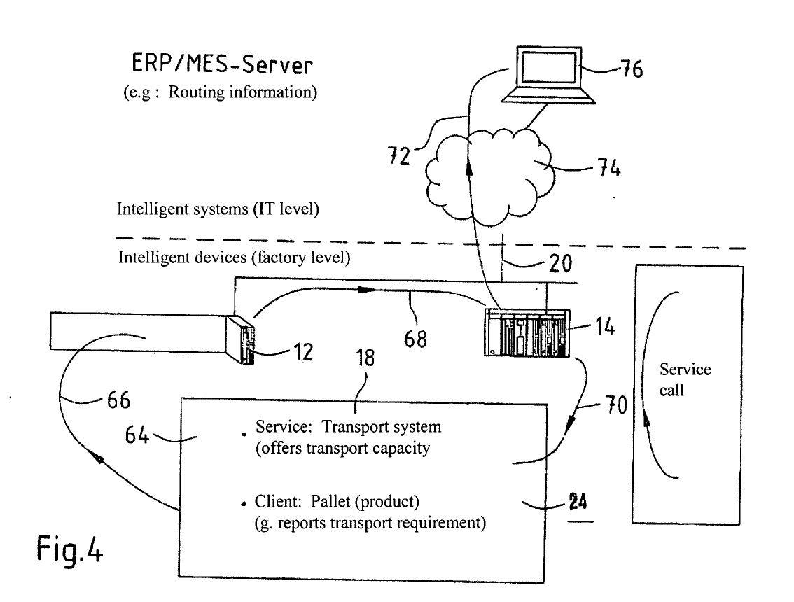

FIG. 4 shows a schematic view of the client-service architecture for different aggregation levels.

FIG. 1 shows a schematic view of a control system 10 and service-oriented architecture for devices distributed in a decentralized manner such as control units 12, 14, 16 in the form of memory-programmable controls (SPS, mini-SPS) or intelligent modules as well as shows electrical and/or mechanical components 18, 20, 22 in the form of transport systems, motors or sensors of a production installation 24.

The devices 12, 14, 16, designated in FIG. 1 as “devices”, can be arranged as memory-programmable control (SPS), mini-SPS distributed in production installation 24 or as intelligent control modules in the form of intelligent actors or sensors. The devices 12, 14, 16 are linked to each other via a data communication system 26 for the exchange of data, which data communication system 26 can be designed as a line bus system or as a wireless radio system. Furthermore, the devices 12, 14, 16 each have physical inputs and outputs 28, 30, 32 for controlling actors and for detecting sensor data.

One or more software components 34-44 is/are implemented in devices 12, 14, 16 via which different services such as, for example, diagnosis, data access or also control operating sequences are made available and invoked.

Thus, on the whole, each of the devices 12, 14, 16 forms a service as a combination of mechatronics, communication and intelligence that are integrated in a total concept that assumes all control tasks.

In the exemplary embodiment of the service-oriented architecture shown at least one software component is designed as a Web service. The service-oriented architecture makes possible a communication with equality of access between the devices 12, 14, 16 without a hierarchy concept being necessary.

FIG. 2 sketches the engineering process for flexible production installations on the basis of a service-oriented architecture.

Production installation 24 is represented by a PPR model containing product, process and resource information. The production process can be represented by a process graph 48 in which partial processes 50, 52, 54 are contained. Each partial process 50, 52, 54 also contains, in addition to logic information, that is, the sequence in time of actions, information about which resources are required for carrying out the particular partial process. The assumption of this information for the development of the services is a decisive design step.

The software components 34, 40, 42 described in FIG. 2 of the devices numbered 12, 14, 16 in FIG. 1, that assume control operating sequences, are derived from one of the partial processes 50, 52, 54. Each software component of a partial process contains a control logic 56 that is developed for a manufacturing process such as, for example, partial process 52 and is derived from process graph 48. Since resources in the form of electrical and mechanical components 18, 20, 22 such as sensors, motors and transport systems are necessary for the processing of partial process 52, a flexible interface 54 is implemented to which resource-specific data are assigned. Resources 18, 20, 22, themselves are represented in the virtual engineering environment (PPR model) in such a manner that their physical behavior is reproduced in the most purposeful manner possible such as, for example, the time used for a movement process.

Finally, the standardized software components 34, 40, 42 are provided with communication interfaces 60, 62. Communication interface 60 is implemented in the case of the service-oriented architecture as Web-based technology and makes possible the communication with other services and therewith an integration in a total concept. Resources 18, 20, 22 can be controlled and their states queried via interface 62.

In this manner software components 34, 40, 42 are derived from all partial processes of the total process operating sequence that can then be implemented in the total system 10 of the service-oriented architecture.

In order to obtain a software component that is standardized as much as possible in which changing frame conditions of the production installation are taken into consideration, a model of a lifecycle for the production installation is developed building on the software components. FIG. 3 shows a course in time of an installation life cycle. At first a definition of consumption of the production installation such as, for example, its transport capacity is performed. The planning of different variants for the flexible operation of the production installation takes place on this basis. The PPR model of the production installation accompanies the installation during its entire life cycle. The PPR model contains virtual images of devices and components of the production installation in which the software components are contained as module.

Based on such modules, the buildup of a virtual model then takes place with a flexible adaptation to different frame conditions in which the partial processes and therewith the control logic of the software components are constantly adapted. In order to raise the flexibility of the software components several variants of partial processes are implemented in the control logic, e.g., tensioning of a sheet with a differing tensioning configuration.

The advantage of the invention is characterized in the planning phase in that a production system can be represented virtually with “intelligent” models of devices and components, in which the “intelligence” of the modules used can be adapted for the flexible operation based on different frame conditions by planning different variants. Then, even a control program for the actual installation can be derived from such a PPR model taking into consideration the installation life cycle in changed frame conditions.

The invention offers the advantage on the hardware level that devices in the form of memory-programmable controls, robotic controls or the like can be flexibly adapted to changing product conditions without an expensive new programming being required.

FIG. 4 shows that different production scenarios can be represented in the form of a client-server architecture and virtually analyzed. For example, in production installation 24 a product 64 is transported on a pallet. The unit consisting of product and pallets is designated in the following as “client”. A service 66 such as “transport requirement” is requested via the data transfer medium 20. The request is routed to device 12 as motor control of a transport structure, which for its part indicates a service request 68 to device 14 such as control of a conversion station. Finally, device 14 calls the general service 70 “transport system”, that that finally offers the requested transport capacity for the transport of the product.

The architecture shown in FIG. 4 also shows that a continuous passage from a central control to decentralized control components 12, 14, 16 can be carried out. For their part, the Web services used can again call other Web services 72. These requests can take place via a global network 74 like the Internet. Web services can be integrated in the IT landscape of a company. For example, a link to an MES 76 (Manufacturing Execution System) can be built up in order to query special routing information.

1. A control system with service-oriented architecture for a flexible production installation, comprising devices distributed in a decentralized manner, coupled to each other via a data communication system for the exchange of data and with at least one software component as well as electrical and/or mechanical components, characterized in that the software component is derived from a process or partial process of a PPR model of the flexible production system, in which each software component comprises a control logic derived from the process or partial process, comprises a flexible interface for access to resources represented in the PPR model as well as comprises a communication interface for integration in the service-oriented architecture.

2. The control system according to claim 1, characterized in that the communication interface is implemented as Web-service-based technology.

3. The control system according to claim 1, characterized in that that the software components and the associated client-server architecture are implemented on different aggregation levels.

4. The control system according to claim 1, characterized in that the software components form a library of generic Web services as Web service.

5. The control system according to claim 1, characterized in that the software component is designed as a Web service.

6. A process for the configuration of a control system by the developing and implementing of service-oriented software components as components of a service-oriented architecture for devices distributed in a decentralized manner in flexible production installations, characterized in that the following process steps are carried out:
Establishing of a PPR model of the flexible production system, taking into consideration product, process and resource information,
Breakdown of a production process contained in the PPR model into partial processes,
Development of the software components on the basis of the partial processes, in which each software component comprises a control logic derived from the partial process, a flexible interface for access to resources represented in the PPR model as well as comprises a communication interface for integration in the service-oriented architecture,
Development and analysis of different production scenarios as client-server architecture,
Implementation of the software components and of the associated client-service architecture into the control system.

7. The process according to claim 6, characterized in that the process steps are carried out in a virtual development environment.
